(19) United States
(12) Patent Application Publication
(10) Pub. No.: US 2025/0211644 A1
(43) Pub. Date: Jun. 26, 2025

(54) Device Deduplication Between Home Networks

(71) Applicant: Google LLC, Mountain View, CA (US)

(72) Inventors: David Roy Schairer, San Jose, CA (US); Alexei Sakhartchouk, Waterloo (CA); David Raymond, San Jose, CA (US); Junjie Bu, Pleasanton, CA (US)

(73) Assignee: Google LLC, Mountain View, CA (US)

(21) Appl. No.: 18/846,992

(22) PCT Filed: May 9, 2023
(86) PCT No.: PCT/US2023/066782

§ 371 Date: Sep. 13, 2024

Related U.S. Application Data
(60) Provisional application No. 63/364,461, filed on May 10, 2022.

(51) Int. Cl. H04L 67/12; H04L 9/06; H04L 67/10

(52) U.S. Cl. CPC H04L 67/12; H04L 9/0643; H04L 67/10

(57) ABSTRACT

Techniques and devices for device deduplication between home networks are described for generating a unique identifier in which an electronic device detects a factory reset and in response to the detecting, generates the unique identifier. The electronic device sends the unique identifier to a first cloud service, the sending being effective to cause the first cloud service to forward the unique identifier to a second cloud service, and the electronic device sends the unique identifier to a hub device in a Matter network, the sending being effective to cause the hub device to forward the unique identifier to the second cloud service.

### BACKGROUND

Using wireless networking to connect devices to each other and to cloud-based services is increasingly popular for sensing environmental conditions, controlling equipment, and providing information and alerts to users for residential and commercial buildings. Many devices on wireless networks are designed to operate for extended periods of time on battery-power which limits the available computing, user interface, and radio resources in the devices.

This increasing popularity has led to multiple vendor-specific ecosystems of devices and networking protocols that may not interoperate. To improve the user experience for these devices and networks, standards, such as the Matter standard, are under development to provide interoperability between devices and services of multiple vendors. When transitioning a Matter-capable device from one vendor ecosystem into a Matter network fabric of another vendor, there are circumstances where multiple (duplicate) identifiers may result from a device's prior identifier(s) and the device's Matter identifier.

### SUMMARY

This summary is provided to introduce simplified concepts of device deduplication between home networks, generally related to generating a unique identifier for a network device. The simplified concepts are further described below in the Detailed Description.

In aspects, methods, devices, systems, and means for device deduplication between home networks are described for generating a unique identifier in which an electronic device detects a factory reset and, in response to the detecting, generates the unique identifier. The electronic device sends the unique identifier to a first cloud service, the sending being effective to cause the first cloud service to forward the unique identifier to a second cloud service, and the electronic device sends the unique identifier to a hub device in a Matter network, the sending being effective to cause the hub device to forward the unique identifier to the second cloud service.

The details of one or more implementations are set forth in the accompanying drawings and the following description. Other features and advantages will be apparent from the description and drawings and from the claims. This summary is provided to introduce subject matter that is further described in the Detailed Description and Drawings.

### BRIEF DESCRIPTION OF THE DRAWINGS

Aspects of device deduplication between home networks are described with reference to the following drawings. The same numbers are used throughout the drawings to reference like features and components:

FIG. 1 illustrates an example network environment in which various aspects of device deduplication between home networks can be implemented.

FIG. 2 illustrates an example home area network system in which various aspects of device deduplication between home networks can be implemented.

FIGS. 3a and 3b illustrate example environments in which aspects of device deduplication between home networks can be implemented.

FIG. 4 illustrates an example method of device deduplication between home networks as in accordance with aspects of the techniques described herein.

FIG. 5 illustrates an example environment in a which a home area network can be implemented in accordance with aspects of the techniques described herein.

FIG. 6 illustrates an example wireless network device that can be implemented in a home area network environment in accordance with one or more aspects of the techniques described herein.

FIG. 7 illustrates an example system with an example device that can implement aspects of device deduplication between home networks.

### DETAILED DESCRIPTION

This document describes techniques and devices to simplify deduplication of device identifiers in Matter networks. A Matter network may include devices from a single manufacturer that also provides cloud services that support those devices, or the Matter network may include devices from one or more partners (partner device manufacturers). Each partner may also provide partner cloud services to support their devices in addition to connectivity the cloud services of the manufacturer and/or the Matter network. Additionally, one partner cloud service may integrate with one or more additional partner cloud services. As a result of connectivity to multiple services, a single device may have multiple identifiers across multiple services. Techniques are described to avoid multiple identifiers for a single device in a Matter network by deduplicating identifiers at the cloud service providing the Matter fabric.

### Example Environment

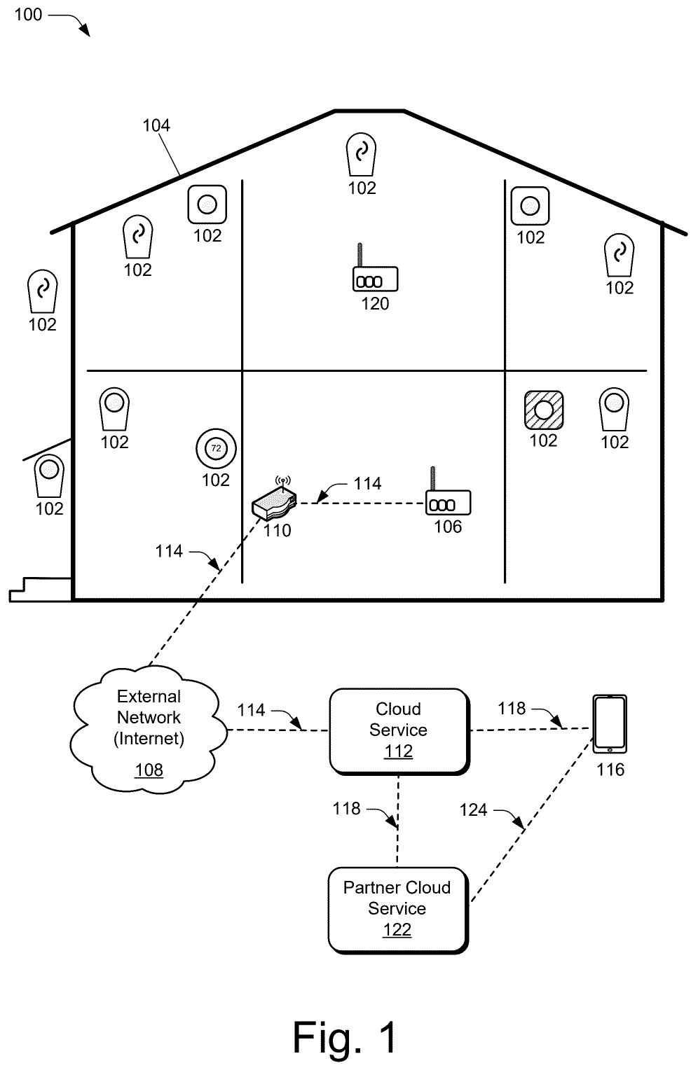

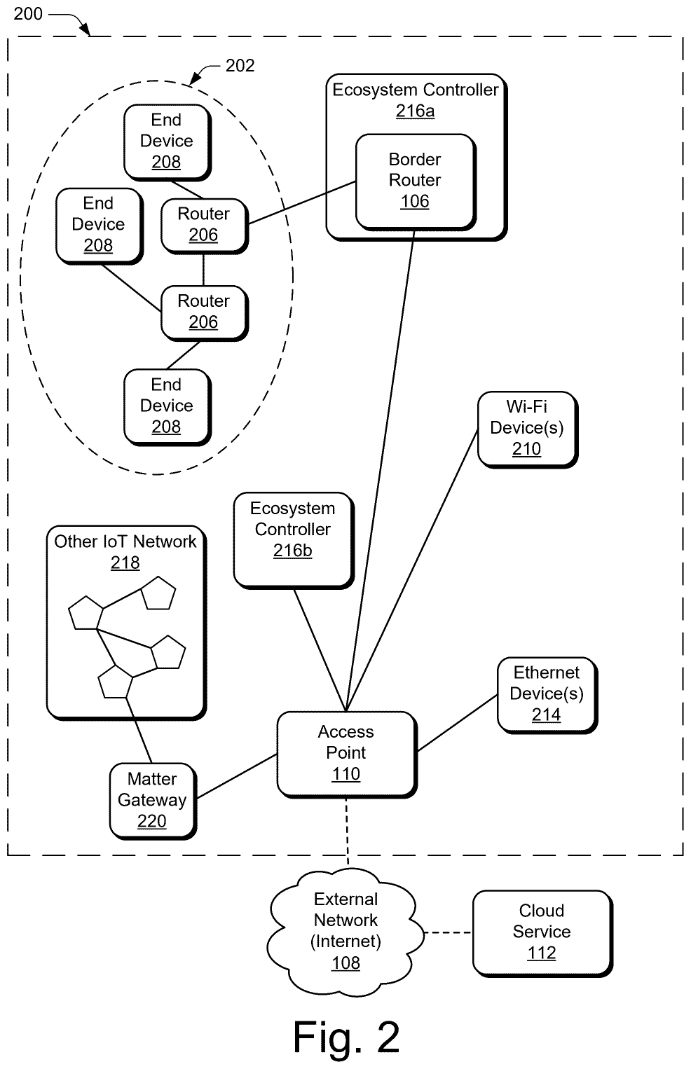

FIG. 1 illustrates an example network environment 100 in which aspects of device deduplication between home networks can be implemented. The network environment 100 includes a home area network (HAN) such as a HAN 200, described below with respect to FIG. 2. The HAN includes wireless network devices 102 that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via border router 106, via a secure tunnel 114 through the external network 108 and the access point 110. The cloud service 112 facilitates communication between the HAN and internet clients 116, such as apps on mobile devices, using an application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, a network-connected speaker, or an application-specific hub, such as a security hub, an energy management hub, an HVAC hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner API 124. The partner cloud service 122 may optionally or additionally provide services to internet clients 116 via the API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example home area network system (e.g., Matter network, Weave network, fabric network) in which various aspects of device deduplication between home networks can be implemented. The home area network (HAN) 200 (Matter network 200) includes a wireless mesh network 202 (e.g., a Thread network) and Wi-Fi device(s) 210. The HAN 200 may also include wired network devices (e.g., Ethernet device(s) 214). The wireless mesh network 202 includes routers 206 and end devices 208. The routers 206 and the end devices 208, each include a mesh network interface for communication over the mesh network 202. The routers 206 receive and transmit packet data over the mesh network interface. The routers 206 also route traffic across the mesh network 202. The end devices 208 are devices that can communicate using the mesh network 202, but lack the capability, beyond simply forwarding to its parent router 206, to route traffic in the mesh network 202. For example, a battery-powered sensor is one type of end device 208. Each Wi-Fi device 210 includes a Wi-Fi network interface for communication over a Wi-Fi network. The Wi-Fi devices 210 and/or the Ethernet devices 214 can include home automation devices as well as devices that include applications to control Matter devices (e.g., a smartphone, a tablet, a network-connected speaker).

An ecosystem controller 216a (e.g., a Matter controller) can include the border router 106, which in turn, is included in the wireless mesh network 202. The border router 106 includes a mesh network interface for communication over the mesh network 202 and a Wi-Fi network interface for communication over the Wi-Fi network 204, or the border router 106 uses the Wi-Fi network interface of the ecosystem controller 216a for communication over the Wi-Fi network 204. The border router 106 routes packets between devices in the wireless mesh network 202 and the access point 110, which can forward packets to other devices in the HAN 200. The border router 106 also routes packets between devices in the mesh network 202 and external network nodes (e.g., the cloud service 112) via the external network 108, such as the Internet, through a home router or access point 110.

The HAN 200 includes one or more ecosystem controllers 216 that provide an interface between devices from an ecosystem vendor and the access point 110. For example, the ecosystem controller 216a provides an interface between the mesh network 202 (a Thread network) and the access point 110. Optionally, the HAN 200 may include other ecosystem controllers, such as ecosystem controller 216b, to interface to devices from other ecosystem vendors. Additionally, other, devices from another IoT network 218 (e.g., non-Matter compatible ecosystem devices) can be connected to the access point 110 by a Matter gateway 220 that provides connectivity for Matter-capable applications to devices in the other IoT network 218.

The devices in the mesh network 202, the Wi-Fi device(s) 210, the Ethernet device(s) 214, the ecosystem controllers 216, and Matter gateway 220 use standard IP routing configurations to communicate with each other through transport protocols such as the User Datagram Protocol (UDP) or the Transmission Control Protocol (TCP).

### Device Deduplication Between Home Networks

Partners who connect devices via both an Application Programming Interface (API) of the manufacturer's cloud service 112 and/or an API of the manufacturer's hub 120, may also make Matter connectivity available to these same devices, including via Matter bridges (e.g., Matter gateway 220). To connect to both the manufacturer's fabric (the manufacturer's cloud service 112 and/or the manufacturer's hub 120) and to the Matter network, the partner must provide a common identifier (ID) so that these partner devices can be identified and merged into the home graph (home devices graph) in the manufacturer's fabric. Additionally, a first partner cloud service may integrate/interface with additional partner cloud services causing the generation of additional identifiers for devices in the home network. Device deduplication assures that a user does not see multiple separate devices for a single device but instead sees the single device, with potentially multiple network paths for command execution that are hidden from the user but that increase the availability of the device availability and preserve existing setups and configurations within the manufacturer's ecosystem.

In aspects, a UniqueID attribute is included in a Matter Basic Information Cluster (and a Bridged Basic Information Cluster for devices behind bridges) and through the device description in a SYNC response of the cloud service 112 or Device Descriptor in a device configuration response of the hub 120. The fields in the Matter Basic Information Cluster (and a Bridged Basic Information Cluster for devices behind bridges) are:
matterUniqueId
matterOriginalVendorId
matterOriginalProductId
   The matterOriginalVendorId and the matterOriginalProductId are optional if the manufacturer of a bridge (e.g., Matter gateway 220) and a bridged device (e.g., a device in the Other IoT Network 218) are the same. The matterUniqueId is a 32-character string and the value of the matterUniqueId is generated each time a device is factory reset. The matterUniqueId must contain the same string as in the Matter BasicCluster and the Matter BridgedBasicCluster. The matterOriginalVendorId and the matterOriginalProductId must be used in bridged cases where the original VendorID and/or ProductID of the device is different from the VendorID and/or ProductID provided by the bridge. For example, in the case of a bridge providing access to other Matter devices, the original VendorID and/or ProductID can be used to deduplicate two views of the same device, with one or more views provided through a bridge. Where the bridged device (e.g., a device in the Other IoT Network 218) is not a Matter bridge or has the same VendorID and/or ProductID as the bridged view, the matterOriginalVendorId and the matterOriginalProductId fields are not necessary. Additionally, the matterOriginalVendorId and the matterOriginalProductId fields support deduplication when multiple partner cloud services integrate with each other, and any of those cloud services creates an additional identifier for a device and communicates the additional device identifier to the cloud service 112. For example, the cloud service 112 can use the matterOriginalVendorId and the matterOriginalProductId fields to uniquely identify a device for which multiple (different) identifiers that multiple partner cloud services 122 have presented to the cloud service 112.

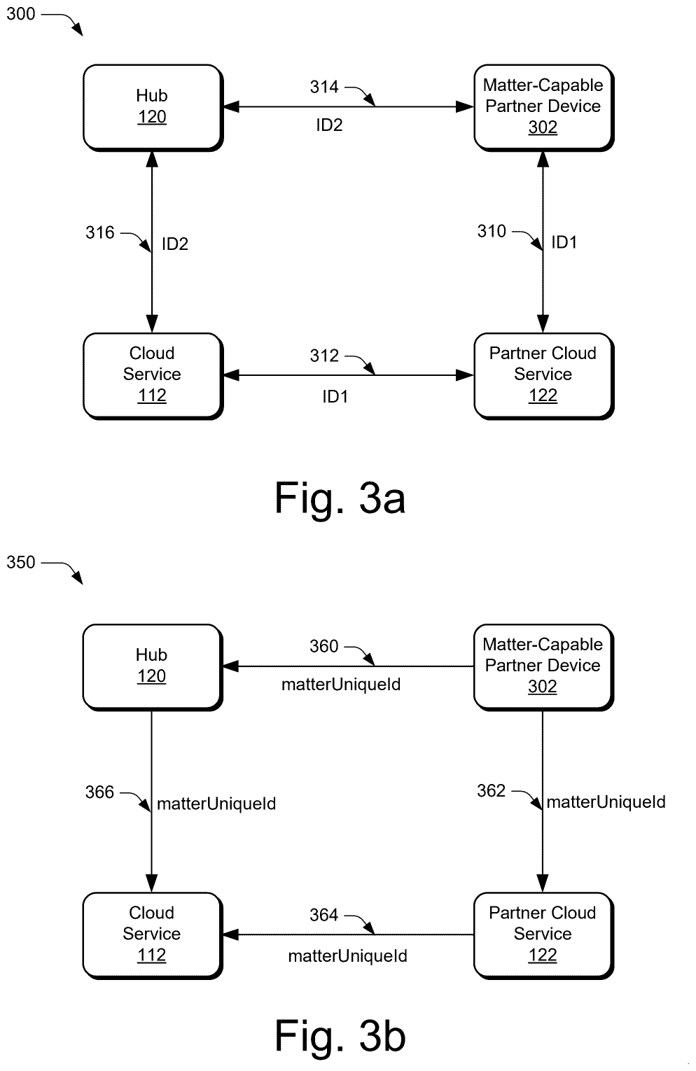

FIGS. 3a and 3b illustrate example environments 300 and 350 in which aspects of device deduplication between home networks can be implemented. The illustrated example includes a cloud service 112, a partner cloud service 122, a hub 120, and a Matter-capable partner device 302. Although, for the sake of illustration clarity, any number of additional devices, such as illustrated in FIG. 1 may be included in the environments 300 and 350.

In FIG. 3a, before joining a Matter network, the Matter-capable partner device 302 may communicate with the partner cloud service 122 using a partner-assigned identifier for the Matter-capable partner device 302, illustrated as ID1 at 310. The partner cloud service 122 may be used by a user to control the Matter-capable partner device 302. Additionally, the user may control the Matter-capable partner device 302 using the cloud service 112. The cloud service 112 can communicate with the partner cloud service 122, at 312, using ID1 for the Matter-capable partner device 302, enabling a user to control the Matter-capable partner device 302 through the services provided by the cloud service 112.

Matter enables the Matter-capable partner device 302 to be controlled directly from the hub 120, at 314, bypassing the cloud services. When the Matter-capable partner device 302 is joined to the Matter network of the hub 120, the Matter-capable partner device 302 may be assigned a new identifier, shown as ID2. When the hub 120 communicates to the cloud service 112 about the newly joined Matter-capable partner device 302 using the ID2, the cloud service now has duplicative identifiers (ID1 and ID2) for the same Matter-capable partner device 302 since the Matter network does not have any knowledge of the cloud service 112.

In FIG. 3b, to resolve the issue of duplicative identifiers when the Matter-capable partner device 302 is joined to the Matter network of the hub 120, the Matter-capable partner device 302 generates a matterUniqueId that is associated with the Matter-capable partner device 302 and communicates the matterUniqueId to the hub 120, at 360. Optionally, a bridge device (e.g., the Matter gateway 220) may provide connectivity between a wireless network device 102, which cannot be upgraded to support the Matter communication protocol, and the hub device 120 with the bridge device communicating a matterUniqueId for the bridged device to the hub 120.

The Matter-capable partner device 302 communicates the matterUniqueId to the partner cloud service 122, at 362. The partner cloud service 122 then communicates the matterUniqueId to the cloud service 112, at 364. With knowledge of the matterUniqueId that is associated with the Matter-capable partner device 302, when the cloud service 112 receives a message regarding the matterUniqueId from the hub 120, at 366, the cloud service 112 can correctly correlate the matterUniqueId with the Matter-capable partner device 302. For example, the cloud service 112 maintains a home graph (home devices graph) that associates devices and attributes of a building structure where the devices are located. The cloud service 112 uses the matterUniqueId to maintain a representation of the state of the Matter-capable partner device 302 and manage any operations associated with the Matter-capable partner device 302. Optionally or additionally, when multiple partner cloud services integrate with each other, and any of those cloud services creates an additional identifier for a device and communicates the additional device identifier to the cloud service 112, the additional partner cloud services also provide the matterOriginalVendorId and the matterOriginalProductId fields to enable the cloud service 112 to deduplicate any additional duplicate device identifiers.

To avoid storing trackable data, the serial number of the Matter-capable partner device 302 is not used for the matterUniqueId. The matterUniqueId is unique, is generated by the Matter-capable partner device 302 and rotates each time a factory reset is performed on the Matter-capable partner device 302. The Matter-capable partner device 302 may generate the matterUniqueId using a permanent device identifier (such as Medium Access Control (MAC) address or any similar identifier uniquely assigned to the Matter-capable partner device and programmed into the device, such as during manufacturing or commissioning) and using cryptographic techniques, such as generating a cryptographic hash of the permanent device identifier and a random seed value to produce the matterUniqueId. The resulting matterUniqueId is a 32-character string. To assure that the matterUniqueId is unique within a Matter network, the matterUniqueId exists within the scope of a vendor identifier (e.g., the matterOriginalVendorId) and a product identifier (e.g., the matterOriginalProductId).

### Example Method

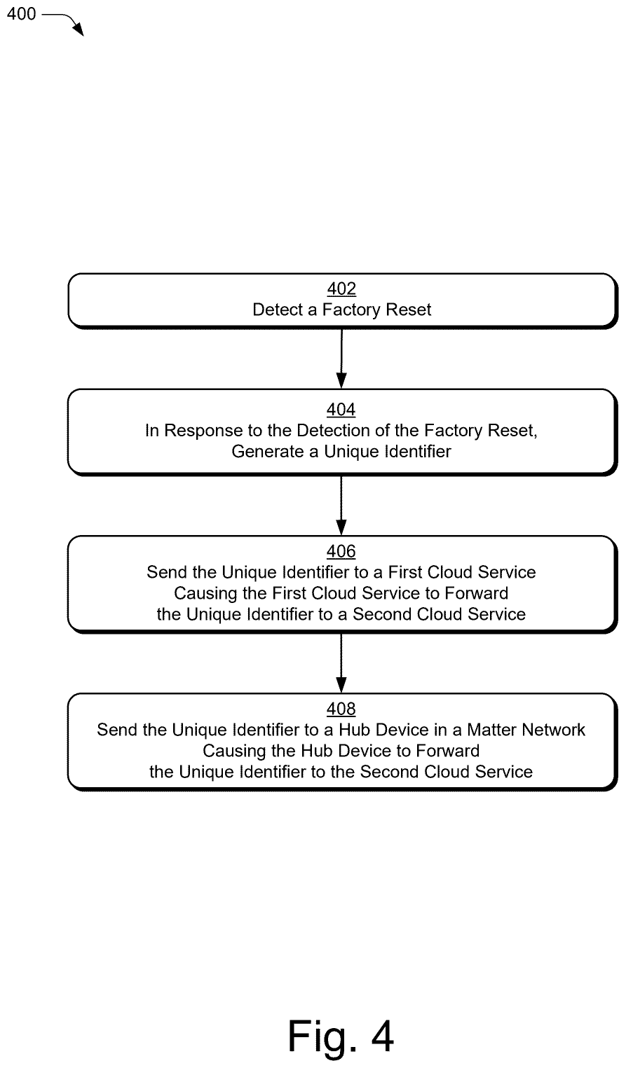

Example method 400 is described with reference to FIG. 4 in accordance with one or more aspects of device deduplication between home networks. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

FIG. 4 illustrates example method(s) 400 of device deduplication between home networks as generally related to the generation of a unique identifier for a network device. At block 402, an electronic device detects a factory reset. For example, an electronic device (e.g., the Matter-capable partner device 302, the wireless network device 102) detects a factory reset, such as receiving an indication to perform a factory reset. The indication to perform the factory reset may be an indication received by a physical interaction with the electronic device (e.g., a user depressing a reset switch), a command received over a wireless network (e.g., from an application on a user device), a firmware update received over the wireless network, powering-up a new Matter-capable device that is being added to the HAN 200, or the like.

At block 404, in response to detecting the factory reset, the electronic device generates a unique identifier for the electronic device. For example, in response to detecting the factory reset, the electronic device generates a unique identifier for the electronic device using a permanent identifier of the electronic device, such as by performing a cryptographic hash of the permanent identifier to produce a matterUniqueId.

At block 406, the electronic device sends the unique identifier to a first cloud service, the sending being effective to cause the first cloud service to forward the unique identifier to a second cloud service. For example, the electronic device sends the unique identifier to a first cloud service (e.g., the partner cloud service 122) that in turn forwards the unique identifier to a second cloud service (e.g., the cloud service 111).

At block 408, the electronic device sends the unique identifier to a hub device in a Matter network, the sending being effective to cause the hub device to forward the unique identifier to the second cloud service. For example, the electronic device sends the unique identifier to a hub device (e.g., the hub device 120) that in turn forwards the unique identifier to the second cloud service. By sending the unique identifier to the second cloud service, the second cloud service can deduplicate multiple device identifiers that the cloud service received for the single electronic device and communicate with the electronic device across multiple network paths using the single, unique identifier.

### Example Environments and Devices

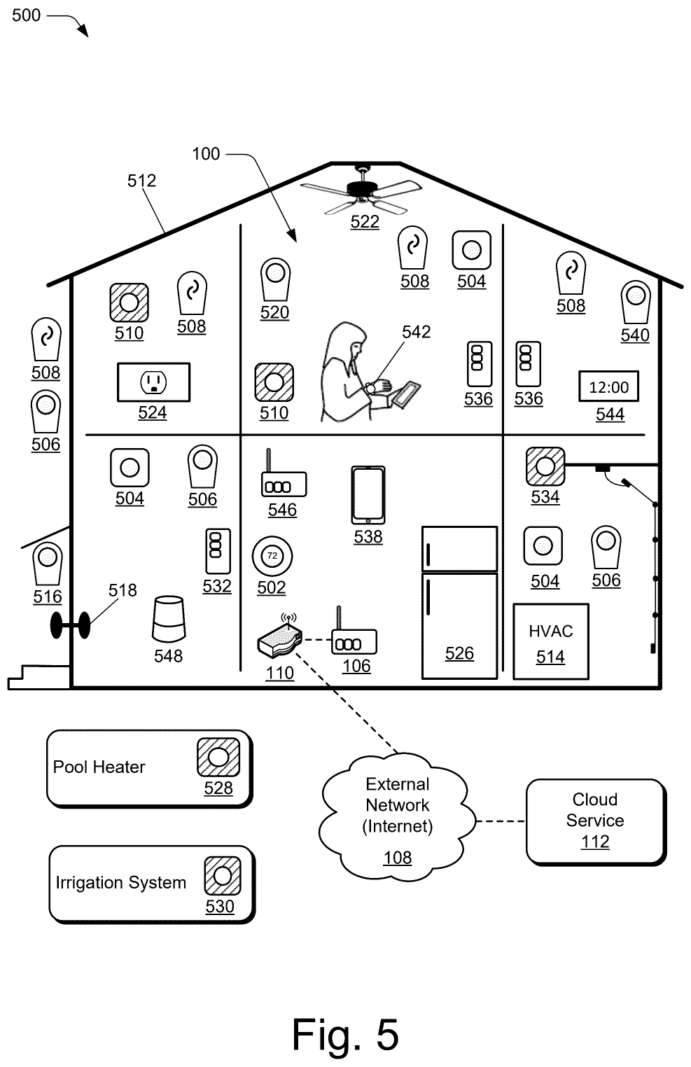

FIG. 5 illustrates an example environment 500 in which a home area network 200, as described with reference to FIG. 2, and aspects of device deduplication between home networks can be implemented. Generally, the environment 500 includes the home area network (HAN) 200 implemented as part of a home or other type of structure with any number of wireless network devices that are configured for communication in a wireless network. For example, the wireless network devices can include a thermostat 502, hazard detectors 504 (e.g., for smoke and/or carbon monoxide), cameras 506 (e.g., indoor and outdoor), lighting units 508 (e.g., indoor and outdoor), and any other types of wireless network devices 510 that are implemented inside and/or outside of a structure 512 (e.g., in a home environment). In this example, the wireless network devices can also include any of the previously described devices, such as a border router 106, as well as any of the devices implemented as a router device 206, an end device 208, an ecosystem controller 216, and/or a Matter gateway 220.

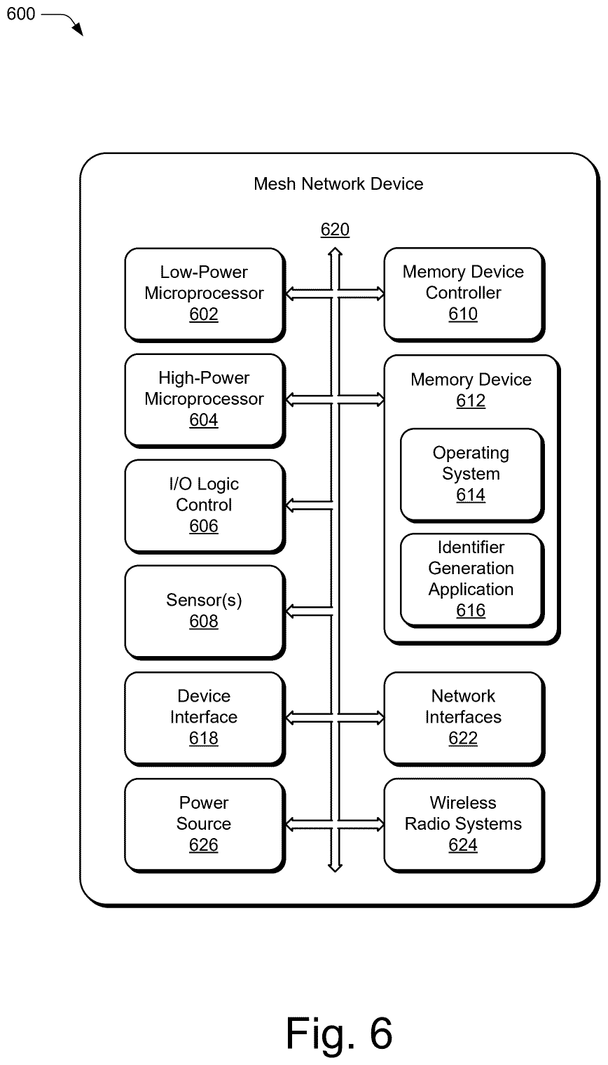

In the environment 500, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 6.

In implementations, the thermostat 502 may include a Nest® Learning Thermostat that detects ambient climate characteristics (e.g., temperature and/or humidity) and controls a HVAC system 514 in the home environment. The learning thermostat 502 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 504 can be implemented to detect the presence of a hazardous substance or a substance indicative of a hazardous substance (e.g., smoke, fire, or carbon monoxide). In examples of wireless interconnection, a hazard detector 504 may detect the presence of smoke, indicating a fire in the structure, in which case the hazard detector that first detects the smoke can broadcast a low-power wake-up signal to all of the connected wireless network devices. The other hazard detectors 504 can then receive the broadcast wake-up signal and initiate a high-power state for hazard detection and to receive wireless communications of alert messages. Further, the lighting units 508 can receive the broadcast wake-up signal and activate in the region of the detected hazard to illuminate and identify the problem area. In another example, the lighting units 508 may activate in one illumination color to indicate a problem area or region in the structure, such as for a detected fire or break-in, and activate in a different illumination color to indicate safe regions and/or escape routes out of the structure.

In various configurations, the wireless network devices 510 can include an entryway interface device 516 that functions in coordination with a network-connected door lock system 518, and that detects and responds to a person's approach to or departure from a location, such as an outer door of the structure 512. The entryway interface device 516 can interact with the other wireless network devices based on whether someone has approached or entered the smart-home environment. An entryway interface device 516 can control doorbell functionality, announce the approach or departure of a person via audio or visual means, and control settings on a security system, such as to activate or deactivate the security system when occupants come and go. The wireless network devices 510 can also include other sensors and detectors, such as to detect ambient lighting conditions, detect room-occupancy states (e.g., with an occupancy sensor 520), and control a power and/or dim state of one or more lights. In some instances, the sensors and/or detectors may also control a power state or speed of a fan, such as a ceiling fan 522. Further, the sensors and/or detectors may detect occupancy in a room or enclosure and control the supply of power to electrical outlets or devices 524, such as if a room or the structure is unoccupied.

The wireless network devices 510 may also include connected appliances and/or controlled systems 526, such as refrigerators, stoves and ovens, washers, dryers, air conditioners, pool heaters 528, irrigation systems 530, security systems 532, and so forth, as well as other electronic and computing devices, such as televisions, network-connected televisions, network-connected media streaming devices, entertainment systems, computers, intercom systems, garage-door openers 534, ceiling fans 522, control panels 536, and the like. When plugged in, an appliance, device, or system can announce itself to the home area network as described above and can be automatically integrated with the controls and devices of the home area network, such as in the home. It should be noted that the wireless network devices 510 may include devices physically located outside of the structure, but within wireless communication range, such as a device controlling a swimming pool heater 528 or an irrigation system 530.

As described above, the mesh network 202 includes a border router 106 that interfaces for communication with an external network, outside the mesh network 202. The border router 106 connects to an access point 110, which connects to the communication network 108, such as the Internet. A cloud service 112, which is connected via the communication network 108, provides services related to and/or using the devices within the HAN 200. By way of example, the cloud service 112 can include applications for connecting end user devices 538, such as smartphones, tablets, and the like, to devices in the home area network, processing and presenting data acquired in the HAN 200 to end users, linking devices in one or more HANs 200 to user accounts of the cloud service 112, provisioning and updating devices in the HAN 200, and so forth. For example, a user can control the thermostat 502 and other wireless network devices in the home environment using a network-connected computer or portable device, such as a mobile phone or tablet device. Further, the wireless network devices can communicate information to any central server or cloud-computing system via the border router 106, an ecosystem controller 216, a Matter gateway 220, and/or the access point 110. The data communications can be carried out using any of a variety of custom or standard wireless protocols (e.g., Wi-Fi, ZigBee for low power, 6LoWPAN, Thread, BLE, Matter, etc.) and/or by using any of a variety of custom or standard wired protocols (Ethernet, HomePlug, etc.).

Any of the wireless network devices in the HAN 200 can serve as low-power and communication nodes to create the HAN 200 in the home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 540 detects that the room is dark and when the occupancy sensor 520 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (i.e., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 508 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 508 that lead to a safe exit. The light units 508 may also be turned-on to indicate the direction along an exit route that a person should travel to safely exit the structure.

The various wireless network devices may also be implemented to integrate and communicate with wearable computing devices 542, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 510 may also include a network-connected alarm clock 544 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 502 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 502 so as to pre-heat or cool the environment to a desired setting and turning-on or turning-off the lights 508.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 500 may include one or more wireless network devices that function as a hub 546. The hub 546 may be a general-purpose home automation hub, or an application-specific hub, such as a security hub, an energy management hub, an HVAC hub, and so forth. The functionality of a hub 546 may also be integrated into any wireless network device, such as a network-connected thermostat device or the border router 106. Hosting functionality on the hub 546 in the structure 512 can improve reliability when the user's internet connection is unreliable, can reduce latency of operations that would normally have to connect to the cloud service 112, and can satisfy system and regulatory constraints around local access between wireless network devices.

Additionally, the example environment 500 includes a network-connected-speaker 548. The network-connected speaker 548 provides voice assistant services that include providing voice control of network-connected devices. The functions of the hub 546 may be hosted in the network-connected speaker 548. The network-connected speaker 548 can be configured to communicate via the wireless mesh network 202, the Wi-Fi network 204, or both.

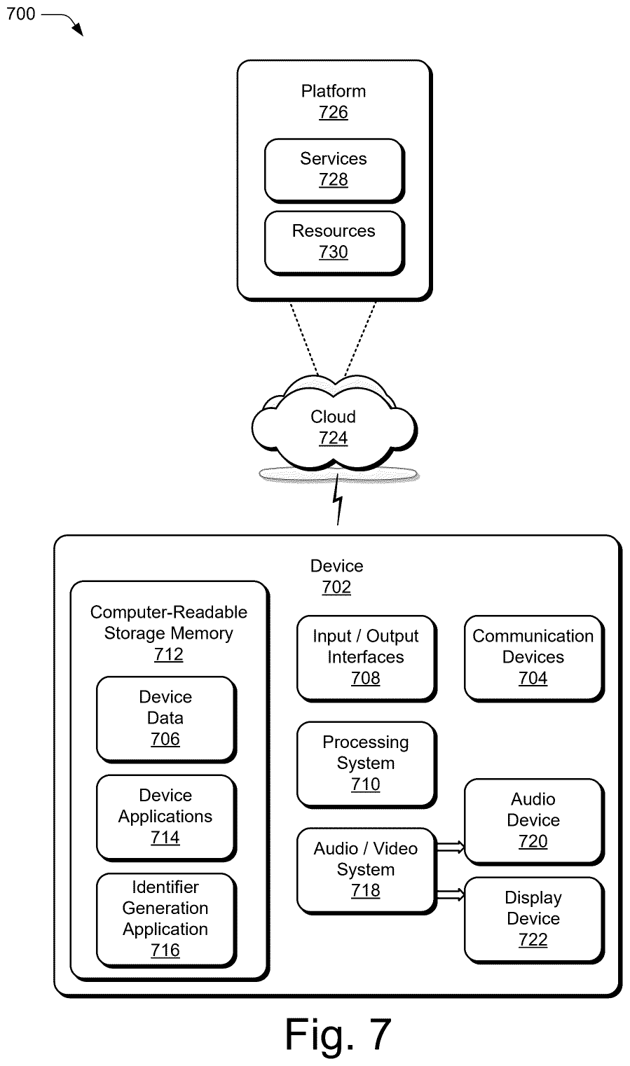

FIG. 6 illustrates an example wireless network device 600 that can be implemented as any of the wireless network devices in a home area network (Thread network, Matter network) in accordance with one or more aspects of device deduplication between home networks as described herein. The device 600 can be integrated with electronic circuitry, microprocessors, memory, input output (I/O) logic control, communication interfaces and components, as well as other hardware, firmware, and/or software to implement the device in a home area network. Further, the wireless network device 600 can be implemented with various components, such as with any number and combination of different components as further described with reference to the example device shown in FIG. 7.

In this example, the wireless network device 600 includes a low-power microprocessor 602 and a high-power microprocessor 604 (e.g., microcontrollers or digital signal processors) that process executable instructions. The device also includes an input-output (I/O) logic control 606 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 602 and the high-power microprocessor 604 can also support one or more different device functionalities of the device. For example, the high-power microprocessor 604 may execute computationally intensive operations, whereas the low-power microprocessor 602 may manage less-complex processes such as detecting a hazard or temperature from one or more sensors 608. The low-power processor 602 may also wake or initialize the high-power processor 604 for computationally intensive processes.

The one or more sensors 608 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 608 may include any one or a combination of temperature sensors, humidity sensors, hazard-related sensors, security sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 600 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 600 includes a memory device controller 610 and a memory device 612, such as any type of a nonvolatile memory and/or other suitable electronic data storage device. The wireless network device 600 can also include various firmware and/or software, such as an operating system 614 that is maintained as computer executable instructions by the memory and executed by a microprocessor. The device software may also include an identifier generation application 616 that implements aspects of device deduplication between home networks. The wireless network device 600 also includes a device interface 618 to interface with another device or peripheral component and includes an integrated data bus 620 that couples the various components of the wireless network device for data communication between the components. The data bus in the wireless network device may also be implemented as any one or a combination of different bus structures and/or bus architectures.

The device interface 618 may receive input from a user and/or provide information to the user (e.g., as a user interface), and a received input can be used to determine a setting. The device interface 618 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 618 may also receive inputs from any number of peripherals, such as buttons, a keypad, a switch, a microphone, and an imager (e.g., a camera device).

The wireless network device 600 can include network interfaces 622, such as a home area network interface for communication with other wireless network devices in a home area network, and an external network interface for network communication, such as via the Internet. The wireless network device 600 also includes wireless radio systems 624 for wireless communication with other wireless network devices via the home area network interface and for multiple, different wireless communications systems. The wireless radio systems 624 may include Wi-Fi, Bluetooth™, Mobile Broadband, BLE, and/or point-to-point IEEE 802.15.4. Each of the different radio systems can include a radio device, antenna, and chipset that is implemented for a particular wireless communications technology. The wireless network device 600 also includes a power source 626, such as a battery and/or to connect the device to line voltage. An AC power source may also be used to charge the battery of the device.

FIG. 7 illustrates an example system 700 that includes an example device 702, which can be implemented as any of the wireless network devices that implement aspects of device deduplication between home networks as described with reference to the previous FIGS. 1-6. The example device 702 may be any type of computing device, client device, mobile phone, tablet, communication, entertainment, gaming, media playback, and/or other type of device. Further, the example device 702 may be implemented as any other type of wireless network device that is configured for communication on a home area network, such as a thermostat, hazard detector, camera, light unit, commissioning device, router, border router, joiner router, joining device, end device, leader, access point, and/or other wireless network devices.

The device 702 includes communication devices 704 that enable wired and/or wireless communication of device data 706, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 704 can also include transceivers for cellular phone communication and/or for network data communication.

The device 702 also includes input/output (I/O) interfaces 708, such as data network interfaces that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 702 includes a processing system 710 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 702 may further include any type of a system bus or other data and command transfer system that couples the various components within the device. A system bus can include any one or combination of different bus structures and architectures, as well as control and data lines.

The device 702 also includes computer-readable storage memory 712 (computer-readable storage media 712), such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 712 provides storage of the device data 706 and various device applications 714, such as an operating system that is maintained as a software application with the computer-readable storage memory and executed by the processing system 710. The device applications may also include a device manager, such as any form of a control application, software application, signal processing and control module, code that is native to a particular device, a hardware abstraction layer for a particular device, and so on. In this example, the device applications also include an identifier generation application 716 that implements aspects of common interface for multicast address subscriptions, such as when the example device 702 is implemented as any of the wireless network devices described herein.

The device 702 also includes an audio and/or video system 718 that generates audio data for an audio device 720 and/or generates display data for a display device 722. The audio device and/or the display device include any devices that process, display, and/or otherwise render audio, video, display, and/or image data, such as the image content of a digital photo. In implementations, the audio device and/or the display device are integrated components of the example device 702. Alternatively, the audio device and/or the display device are external, peripheral components to the example device. In aspects, at least part of the techniques described for common interface for multicast address subscriptions may be implemented in a distributed system, such as over a “cloud” 724 in a platform 726. The cloud 724 includes and/or is representative of the platform 726 for services 728 and/or resources 730.

The platform 726 abstracts underlying functionality of hardware, such as server devices (e.g., included in the services 728) and/or software resources (e.g., included as the resources 730), and connects the example device 702 with other devices, servers, etc. The resources 730 may also include applications and/or data that can be utilized while computer processing is executed on servers that are remote from the example device 702. Additionally, the services 728 and/or the resources 730 may facilitate subscriber network services, such as over the Internet, a cellular network, or Wi-Fi network. The platform 726 may also serve to abstract and scale resources to service a demand for the resources 730 that are implemented via the platform, such as in an interconnected device aspect with functionality distributed throughout the system 700. For example, the functionality may be implemented in part at the example device 702 as well as via the platform 726 that abstracts the functionality of the cloud 724.

In the following some examples are described:

Example 1: A method of generating a unique identifier by an electronic device, the method comprising:
detecting, by the electronic device, a factory reset;
in response to the detecting, generating the unique identifier;
sending the unique identifier to a first cloud service, the sending being effective to cause the first cloud service to forward the unique identifier to a second cloud service; and
sending the unique identifier to a hub device in a Matter network, the sending being effective to cause the hub device to forward the unique identifier to the second cloud service.
   Example 2: The method of example 1, wherein performing the factory reset comprises:
joining the Matter network that includes the hub device.
   Example 3. The method of example 1 or example 2, wherein the unique identifier randomly rotates each time the electronic device performs a factory reset.
   Example 4: The method of any one of the preceding examples, wherein the generating the unique identifier comprises:
generating the unique identifier using a permanent identifier of the electronic device.
   Example 5: The method of example 4, wherein the generating the unique identifier using the permanent identifier of the electronic device comprises:
generating a cryptographic hash of the permanent identifier and a random seed value.
   Example 6: The method of any one of the preceding examples, wherein the sending the unique identifier to the first cloud service and the sending the unique identifier to a hub device in a Matter network enables the second cloud service to deduplicate multiple device identifiers to uniquely identify the electronic device across multiple network connections using the unique identifier.
   Example 7: The method of any one of the preceding examples, wherein the sending the unique identifier to the hub device in a Matter network comprises:
sending the unique identifier to the hub device in the Matter network via a bridge device.
   Example 8: The method of any one of the preceding examples, wherein the unique identifier is a 32-character string.
   Example 9: The method of any one of the preceding examples, wherein the unique identifier is unique within a scope of a vendor identifier and a product identifier of the electronic device.
   Example 10: The method of any one of the preceding examples, wherein the unique identifier is a matterUniqueId.
   Example 11: The method of example 10, wherein the matterUniqueId is included in a Matter Basic Information Cluster.
   Example 12: The method of example 11, wherein the Matter Basic Information Cluster includes:
a matterOriginalVendorId of the electronic device; and
a matterOriginalProductId of the electronic device.
   Example 13: An electronic device comprising:
a wireless network interface;
a processor; and
computer-readable storage media comprising instructions that, responsive to execution by the processor, direct the electronic device to perform a method as recited in any one of examples 1 to 12.
   Example 14: The electronic device of example 13, wherein the electronic device is:
a thermostat;
a hazard detector;
a camera;
a lighting unit;
an entryway interface;
a door lock;
an occupancy sensor;
a ceiling fan;
an electrical outlet;
a security sensor;
a security hub;
a garage-door opener;
a control panel;
a border router;
a hub;
a network-connected speaker;
a television;
a network-connected television;
a network-connected media streaming device; or
any combination thereof.
   Example 15: Computer-readable storage media comprising instructions, responsive to execution by a processor, for directing an apparatus to perform a method as recited in any one of examples 1 to 12.

Although aspects of device deduplication between home networks have been described in language specific to features and/or methods, the subject of the appended claims is not necessarily limited to the specific features or methods described. Rather, the specific features and methods are disclosed as example implementations of device deduplication between home networks, and other equivalent features and methods are intended to be within the scope of the appended claims. Further, various different aspects are described, and it is to be appreciated that each described aspect can be implemented independently or in connection with one or more other described aspects.

1. A method of generating a unique identifier by an electronic device, the method comprising:
detecting, by the electronic device, a factory reset;
in response to the detecting, generating the unique identifier;
sending the unique identifier to a first cloud service, the sending being effective to cause the first cloud service to forward the unique identifier to a second cloud service; and
sending the unique identifier to a hub device in a Matter network, the sending being effective to cause the hub device to forward the unique identifier to the second cloud service.

2. The method of claim 1, wherein performing the factory reset comprises:
joining the Matter network that includes the hub device.

3. The method of claim 1, wherein the unique identifier randomly rotates each time the electronic device performs a factory reset.

4. The method of claim 1, wherein the generating the unique identifier comprises:
generating the unique identifier using a permanent identifier of the electronic device.

5. The method of claim 4, wherein the generating the unique identifier using the permanent identifier of the electronic device comprises:
generating a cryptographic hash of the permanent identifier and a random seed value.

6. The method of claim 1, wherein the sending the unique identifier to the first cloud service and the sending the unique identifier to a hub device in a Matter network enables the second cloud service to deduplicate multiple device identifiers to uniquely identify the electronic device across multiple network connections using the unique identifier.

7. The method of claim 1, wherein the sending the unique identifier to the hub device in a Matter network comprises:
sending the unique identifier to the hub device in the Matter network via a bridge device.

8. The method of claim 1, wherein the unique identifier is a 32-character string.

9. The method of claim 1, wherein the unique identifier is unique within a scope of a vendor identifier and a product identifier of the electronic device.

10. The method of claim 1, wherein the unique identifier is a matterUniqueId.

11. The method of claim 10, wherein the matterUniqueId is included in a Matter Basic Information Cluster.

12. The method of claim 11, wherein the Matter Basic Information Cluster includes:
a matterOriginalVendorId of the electronic device; and
a matterOriginalProductId of the electronic device.

13. An electronic device comprising:
a wireless network interface;
a processor; and
computer-readable storage media comprising instructions executable by the processor to direct the electronic device to:
detect a factory reset;
in response to the detection of the factory reset, generate a unique identifier;
send the unique identifier to a first cloud service that is effective to cause the first cloud service to forward the unique identifier to a second cloud service; and
send the unique identifier to a hub device in a Matter network that is effective to cause the hub device to forward the unique identifier to the second cloud service.

14. (canceled)

15. (canceled)

16. The electronic device of claim 13, wherein the instructions to perform the factory reset are further executable by the processor to direct the electronic device to:
join the Matter network that includes the hub device.

17. The electronic device of claim 13, wherein the unique identifier randomly rotates each time the electronic device performs a factory reset.

18. The electronic device of claim 13, wherein the instructions to generate the unique identifier are further executable by the processor to direct the electronic device to:
generate the unique identifier using a permanent identifier of the electronic device.

19. The electronic device of claim 18, wherein the instructions to generate the unique identifier using the permanent identifier of the electronic device are further executable by the processor to direct the electronic device to:
generating a cryptographic hash of the permanent identifier and a random seed value.

20. The electronic device of claim 13, wherein the sending of the unique identifier to the first cloud service and the sending of the unique identifier to a hub device in a Matter network enables the second cloud service to deduplicate multiple device identifiers to uniquely identify the electronic device across multiple network connections using the unique identifier.

21. The electronic device of claim 13, wherein the electronic device is:
a thermostat;
a hazard detector;
a camera;
a lighting unit;
an entryway interface;
a door lock;
an occupancy sensor;
a ceiling fan;
an electrical outlet;
a security sensor;
a security hub;
a garage-door opener;
a control panel;
a border router;
a hub;
a network-connected speaker;
a television;
a network-connected television;
a network-connected media streaming device; or
any combination thereof.

22. Non-transitory computer-readable storage media comprising instructions, responsive to execution by a processor, for directing an apparatus to:
detect a factory reset;
in response to the detection of the factory reset, generate a unique identifier;
send the unique identifier to a first cloud service that is effective to cause the first cloud service to forward the unique identifier to a second cloud service; and
send the unique identifier to a hub device in a Matter network that is effective to cause the hub device to forward the unique identifier to the second cloud service.
